(19) United States
(12) Patent Application Publication
(10) Pub. No.: US 2009/0002465 A1
(43) Pub. Date: Jan. 1, 2009

(54) INK STORAGE DEVICE AND AN INK CARTRIDGE OF THE SAME

(76) Inventors: Takahiro Maki, Taipei (TW); Naoyuki Matsui, Taipei (TW)

Correspondence Address: Takahiro Maki, 235 Chung - Ho, Box 8-24, Taipei, TW

(21) Appl. No.: 12/145,499

(22) Filed: Jun. 24, 2008

(30) Foreign Application Priority Data
Jun. 29, 2007 (JP) JP 2007-172164

(51) Int. Cl. B41J 2/175

(52) U.S. Cl. 347/86; 347/87

(57) ABSTRACT

An ink cartridge and an ink storage device including the same are provided, which has a stable quality, lower ink residue, less components, lower cost, and low impact to the environment. The ink storage device is assembled by an ink receiving portion, a sleeve, and a pin plug. The ink receiving portion is formed by welding and sealing the edges of a pair of plates. The sleeve has a first end portion and a respective second end portion. The first end portion is connected to the ink receiving portion and the second end portion exposes out of the ink receiving portion. An interior of the sleeve has a penetrating hole connecting the ink receiving portion. The pin plug is made of an elastic material and is installed to the second end portion of the sleeve. A storage portion for storing the ink is formed in the pin plug, and an end of the pin plug is formed as a linking hole linking the ink receiving portion with the storage portion through the penetrating hole. Another end of the pin plug is formed as with cut which is acted as a function of valve.

### FIELD OF INVENTION

The present invention relates to ink storage device of a picture forming unit, such as a ink jet printer and the ink cartridge receiving the ink storage device, and in particular to an ink storage device and an ink cartridge providing stable ink supply and lowering environment impact.

### BACKGROUND OF THE INVENTION

The picture forming unit using ink, such like an ink jet printer, is very common recently. So called printer device has a movable carriage carrying an ink nozzle and an ink cartridge storing the ink so as to process printing operations through the nozzle to jet out the ink.

For a prior ink cartridge carried by a printing device as shown in FIG. 10, a top-to-bottom extending first isolating wall 115 is formed in a box-shape ink cartridge 100. Through the first isolating wall 115, an air chamber 117 is isolated from an ink receiving chamber 111 and an ink preserving chamber 113. In a bottom of the first isolating wall 115, an air way 115a is formed between the air chamber 117 and the ink preserving chamber 113. Moreover, an air inlet 116 is formed on a top of the air chamber 117. Beside, for the purpose of separating the ink receiving chamber 111 and the ink preserving chamber 113, a second isolating wall 112 is formed at a middle level of the ink cartridge 100. On the second isolating wall 112, an ink pass 112a is formed between the ink receiving chamber 111 and the ink preserving chamber 113, and the water soluble ink 101 is received inside the ink receiving chamber 111. On the other hand, an ink preserving device 102 is filled in the ink preserving chamber 113. The ink preserving device 102 is made of polyurethane sponge which has a volume of 1.5 times larger than that of the ink preserving chamber 113, a specific gravity of 0.05 g/cc, and a hollow hole mean diameter of 0.2 mm. When the ink 101 stored in the ink receiving chamber 111 passes through the ink pass 112a to the ink preserving chamber 113, the ink preserving device 102 can preserve the ink there within. Moreover, for the purpose of supplying the ink 101 to the nozzle, an ink outlet 114 is formed in a bottom of the ink preserving chamber 113.

The above mentioned prior art ink cartridge 100 uses a porous medium of polyurethane sponge as an ink preserving device 102 for preserving the ink 101, and prevent an unnecessary leakage of the ink 101 from the ink outlet 114. However, the porous medium exists a mass, the ink 101 preserved inside the porous medium is about half of the total mass of the porous medium. Therefore, filling of the compressed porous medium inside the ink preserving chamber 113 will limit the content of the ink 101 among the capacity of the ink cartridge 100.

Moreover, because of the structure of porous medium can preserve the ink 101, it is difficult to completely exhaust the ink inside the porous medium through a common operation. Therefore, it is impossible to use all of the ink 101 in the ink cartridge 100 with the porous medium inside. However, the ink supply through the ink outlet 114 will become unstable when the quantity of the ink is low. For example, when the quantity of the ink becomes 30 percent of the origin quantity, the printer device will not work normally because of the unstable supply of the ink. The ink cartridge 100 of above example will be abandoned and then more impacts will apply to our environment.

Furthermore, the ink cartridge 100 disclosed according to the prior art has an air inlet 116. The air inlet 116 is sealed before the ink cartridge 100 is installed to the printer device for preventing the ink from leaking from the ink pass 114. Therefore, user needs to remove the seal of the air inlet 116 from a new ink cartridge 100 before using it. However, removing of the seal is not only a nuisance to user, but also causes malfunctions like missing dot, blurred dot, or blocked nozzle. The cause is while the seal is not removed entirely, the air will not flow into the ink cartridge 100 so that the ink 101 will not flow out from the ink way 114.

Before an ink cartridge 100 is installed to a printer device, the ink 101 can go into the air chamber 117 and the air inlet 116 because of vibrations. Under that situation, the ink could splash and stain around while a user is removing the seal on the air inlet 116.

Moreover, for the ink to flow smoothly in the porous medium, a solvent process is needed. The gas bubble contained in the porous medium should be removed before a filling process. The solvent process will cause a raise of cost because it is time-consuming and plenty of production equipments are needed.

### SUMMARY OF THE PRESENT INVENTION

Accordingly, the primary object of the present invention is to correct the disadvantage of the prior art and to provide an ink cartridge and an ink storage device including the ink cartridge; which has a stable quality, lower ink residue, less components, lower cost, and less impacts to environment.

To achieve above object, the present invention provides an ink storage device comprising an ink receiving portion, a sleeve, and a pin plug, wherein the ink receiving portion is formed by a pair of plates which are combined by welding and sealing; the sleeve has a first end portion and a second end portion; the first end portion being communicated to the ink receiving portion and the second end portion exposes out of the ink receiving portion, and a penetrating hole is formed in the sleeve and is communicated to the ink receiving portion; the pin plug is made of an elastic material and is installed to the second end portion of the sleeve; a storage portion for storing the ink is formed in the pin plug, and an end of the pin plug is formed as a linking hole linking the ink receiving portion with the storage portion through the penetrating hole; another end of the pin plug is formed as a cut which is acted as valve.

The edges of the pair of plates clamp the first end of the sleeve and peripheries of the plates are welded so as to be fixed with the sleeve.

The penetrating hole has a diameter-enlarged space at an opening in the second end of the sleeve and the pin plug is plugged and fixed into the space.

An ink cartridge including an ink storage device as above said and a frame for receiving the ink storage device are included.

The frame is formed by a casing and a cover; the casing is a box having an opening, and the cover covers upon an opening of the casing; the casing has an arranging portion for receiving the ink storage device and an exposing portion for fixing the sleeve and exposing out a second end portion of the sleeve.

The sleeve has at least one notch, and at least one of the casing and the cover is formed with a positioning rib which is retained to the notch so as to determine a position of the ink storage device.

The opening of the casing has welding ribs and the cover has welding grooves at positions corresponding to those of the welding ribs.

An inner wall of the cover facing the opening of the casing is formed with at least one inserting pin; a column sustaining portion is formed on a corresponding position in the casing; and a receiving hole receiving the inserting pin is formed on a top of the column sustaining portion.

Through the technique disclosed by the present invention, the following benefits can be achieved.

1. The ink storage device of the present invention is assembled by an ink receiving portion, a sleeve, and a pin plug. By the function of valve of the pin plug, the ink will not leak or drop while not being used and also help to reduce the components of the ink storage device. Beside, a structure of air inlet in the prior art is replaced by a sealed ink receiving portion. The ink in such ink receiving portion will not be influenced by the variation of the temperature, pressure, and vibration of the surroundings. Moreover, the ink supply is stable because there is no air inflow so as there is no bubble generated. Also, there is a storage portion inside the pin plug for storing the ink, so that a proper supply of the ink through the valve function of the cut can be achieved.

Additional, the ink storage device with above structure does not use the porous medium for preserving the ink like the prior art, the ink can be stably and entirely used before abandoned with zero residue so as to lower the impact to our environment.

2. The ink receiving portion of the ink storage device disclosed by the present invention is formed by fixing a pair of plates and a sleeve, the manufacturing is simple and the fixed structure is highly airtight.

3. The ink storage device disclosed by the present invention is formed with a space by enlarging the diameter of the penetrating hole of the second end portion, and the pin plug is plugged and fixed into the space. The replacement of plug will be easy, and even a pin plug made of a softer material will not easily deteriorate under the external protection of the sleeve.

4. The ink storage device disclosed by the present invention can fill the ink through the cut of the pin plug by a nozzle, and thus it is more convenient and need less cost.

5. In the ink cartridge disclosed by the present invention, the frame for receiving the ink storage device will not need an air inlet or an isolating wall separating the ink receiving chamber and the air chamber like the prior art. The simply structure of the casing and cover can be manufactured inexpensive so that the cost can be controlled.

6. The ink cartridge disclosed by the present invention has positioning ribs and notches for determining the position of the ink storage device, so that the vibration or seal breaking of the ink storage device inside the frame can be restrained.

7. The ink cartridge disclosed by the present invention is formed with welding ribs and welding grooves on the welding area on the opening of casing and relative positions on the cover, so that the contact area of the welding portion is enlarged and a firm connection is achieved.

8. The ink cartridge disclosed by the present invention has the inserting pins on the cover and the relative column sustaining portions in the casing so that the connection between the casing and the cover is firm.

The various objects and a best embodiment of the present invention will be more readily understood form the following detailed description when read in conjunction with the appended drawing. However, the embodiment of the ink cartridge and its ink storage device of the technique of the present invention is not used to confine the scope and spirit of the present invention defined in the appended claims.

### BRIEF DESCRIPTION OF THE DRAWINGS

FIG. 1 is an exploded perspective view showing the first embodiment of a disassembled ink cartridge of the present invention.

FIG. 2 is a lateral perspective view viewed from a lateral side of the ink storage device without filling with ink.

FIG. 3 is a cross sectional view showing the ink storage device of the present invention being filled with ink.

FIGS. 4A, 4B, 4C and 4D are schematic views showing the sleeve of the ink storage device according to the present invention; where FIG. 4A is a front view, FIG. 4B is a right side view, FIG. 4C is a left side view, and FIG. 4D is a cross section view viewed from the IVD-IVD line of FIG. 4B.

FIGS. 5A, 5B and 5C are schematic views of the pin plug of the present invention which is installed in the sleeve shown in FIGS. 4A, 4B and 4C; where FIG. 5A is a front view, FIG. 5B is a right side view, FIG. 5C is a left side view, and FIG. 5D is a cross section view viewed from the VD-VD line of FIG. 5B.

FIGS. 6A, 6B and 6C are schematic views of the casing of the present invention; wherein FIG. 6A is a front view, FIG. 6B shows the lower part of a partial cross section of FIG. 6A; and FIG. 6C is a cross section view along line VIC-VIC of FIG. 6A.

FIGS. 7A and 7B are schematic views of the cover; FIG. 7A is a rear view, FIG. 7B is a view showing from the bottom of FIG. 7A.

FIG. 8 is a schematic view of the embodiment of variation of the casing; FIG. 8A is a front view, FIG. 8B is a bottom view of a partial cross section of FIG. 8A.

FIGS. 9A and 9B are schematic views of the embodiment of variation of the cover; wherein FIG. 9A is a rear view, FIG. 9B is a view showing from the bottom of FIG. 9A.

FIG. 10 is a cross section view showing the use of the prior art.

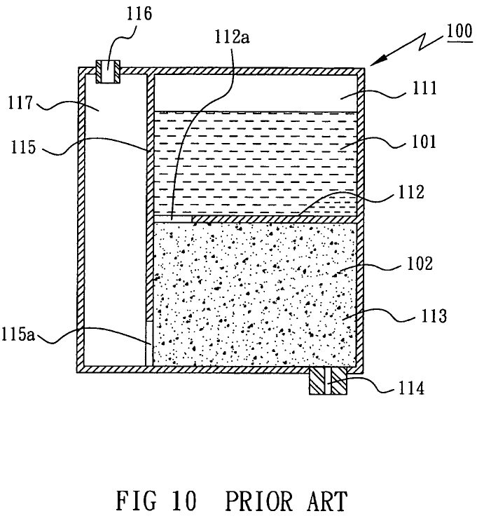

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

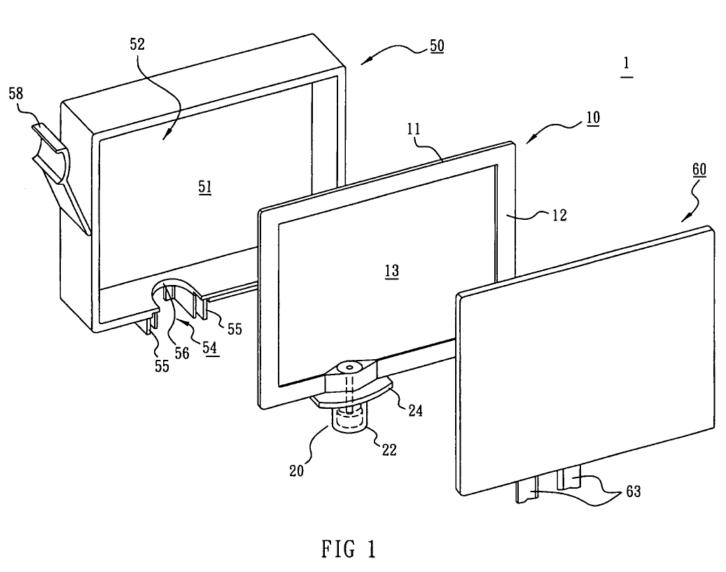

FIG. 1 shows the ink cartridge 1 according to the present invention. The ink cartridge 1 has an ink storage device 10 and a frame for receiving the ink storage device 10. The frame includes a casing 50 and a cover 60. The casing 50 is a box with an opening 52 at one side thereof and the cover 60 covers upon the opening 52 of the casing 50.

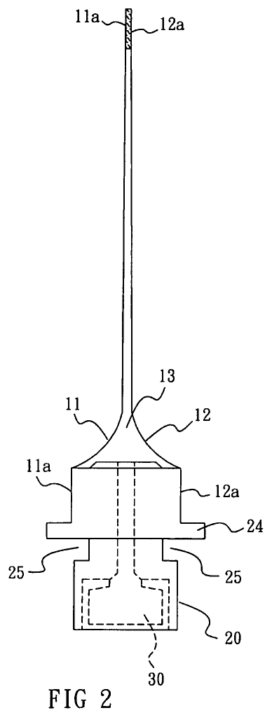

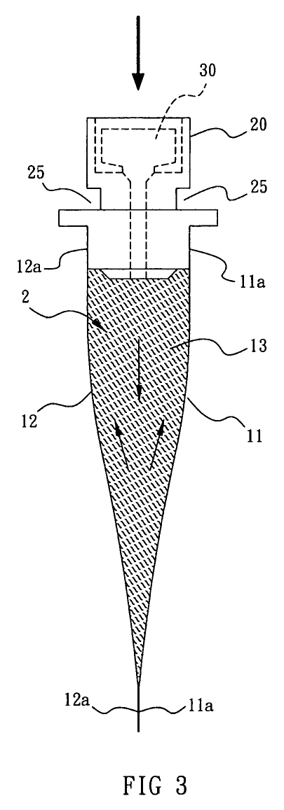

Referring to FIGS. 2 and 3, the ink storage device 10 is formed by a pair of nonflammable resin plates 11, 12, a sleeve 20 and a pin plug 30. Each of the nonflammable resin plates 11, 12 is formed by overlapping a plurality of different nonflammable resin materials and is a rectangular plate having a size compatible to the casing 50. Peripherals of the nonflammable resin plates 11, 12 are formed with connecting portions 11a, 12a. By heat-welding with a sealing machine (press machine), the connecting portions 11a, 12a will seal the nonflammable resin plates 11, 12 so as to form an ink receiving portion 13 thereof.

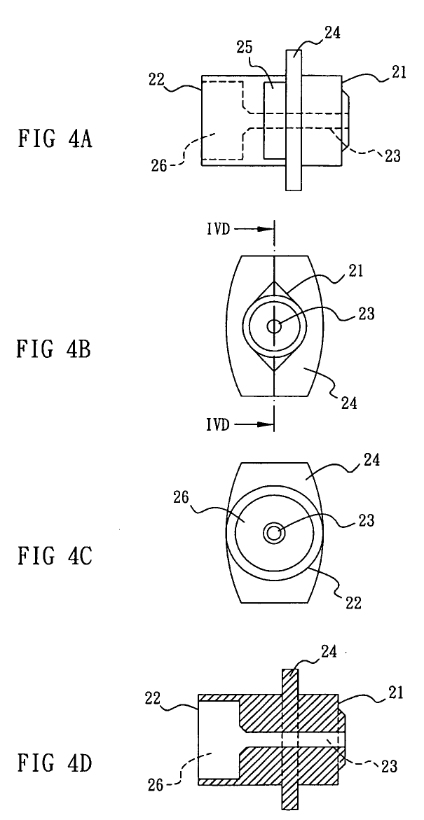

Referring to FIGS. 4A, 4B, 4C and 4D, the sleeve 20 is a round cylinder made of, preferably, resin. The sleeve 20 has a first end portion 21 and a respective second end portion 22. The first end portion 21 is connected to the ink receiving portion 13 and the second end portion 22 is exposed out of the ink receiving portion 13. Along a longitudinal direction of the sleeve 20, an interior of the sleeve 20 has a penetrating hole 23 for connecting the first end portion 21 and the second end portion 22. A flange 24 is protruded from an outer middle area of the sleeve 20. When the sleeve 20 is connected to the nonflammable resin plates 11, 12, the flange 24 serves to confine the connecting portion of the sleeve 20 to the nonflammable resin plates 11, 12. A wall between the flange 24 and the second end portion 22 near a middle area of the sleeve 20 has two opposite notches 25 for embedding positioning ribs 56, 64 for fixing the casing 50 and the cover 60. A lateral side of a portion from the flange 24 to the first end portion 21 is formed with a shape like a convex lens so that the nonflammable resin plates 11, 12 are formed as seamless welding connection. Moreover, a side of the penetrating hole at the second end portion 22 is formed with a round disk-like space 26 for receiving the pin plug 30.

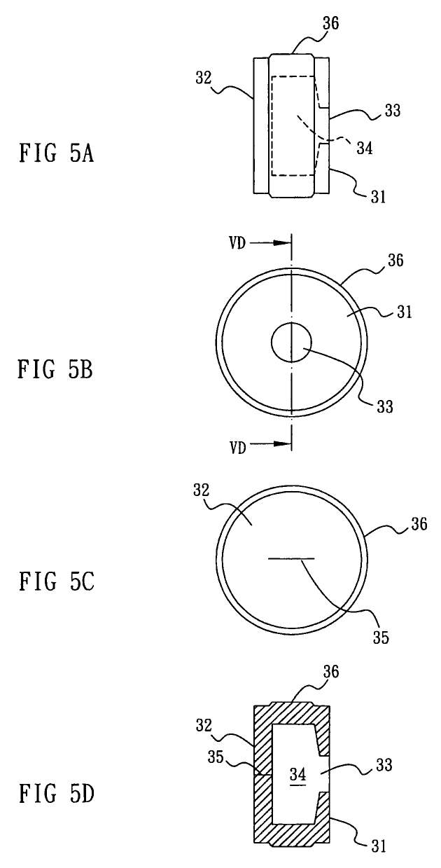

As shown in FIGS. 5A, 5B, 5C and 5D, the pin plug 30 is made of an elastic resin cylinder-like material, such as silicones or rubbers. The length of an axial direction of the pin plug 30 is approximately equal to that of an axial direction of the round disk-like space 26 formed in the sleeve 20. A linking hole 33 is formed in a center of an end portion 31 of the pin plug 30, and the linking hole 33 serves to connect to the penetrating hole 23 of the sleeve 20. Moreover, a storage portion 34 for storing ink 2 is formed inside the pin plug 30, and the storage portion 34 is connected to the linking hole 33. Besides, in another end portion 32 which is an opposite end to the end portion 31 of the pin plug 30, a cut 35 with a predetermined length is formed about a center area. The cut 35 has a function of “valve” because the pin plug 30 is made of elastic resin. Detailed, the cut 35 is a gap formed as preventing the passage of the ink 2 in a normal state, and the ink 2 can only pass the cut 35 while the pin plug 30 is elastically deformed by an external force and thus the cut 35 is opened. Furthermore, beside the peripherals of the end portions 31 and 32 of the pin plug 30, a round rib 36 protruding from the peripheral is formed. The round rib 36 presses an inner wall of the round disk-like space 26 formed in the sleeve 20 while the pin plug 30 is inserted into the sleeve 20. By the pressing force, the pin plug 30 can be fixed into the round disk-like space 26 of the sleeve 20.

The structure of ink storage device 10 assembled by the components mentioned above and the filling of the ink storage device 10 will be described with reference of FIGS. 2 and 3 in the following.

Firstly, the assembly of the ink storage device 10 will be described. The pin plug 30 is inserted into the round disk-like space 26 formed in the second end portion 22 of the sleeve 20, and the pin plug 30 is fixed so that another end portion 32 thereof and the second end portion 22 of the sleeve 20 are approximately at the same level. With the linking hole 33 of the pin plug 30 attaching to the penetrating hole 23 of the sleeve 20, a connection is formed. Secondly, a side of the first end portion 21 of the sleeve 20 inserted by the pin plug 30, that is, a portion of an outer side from the first end portion 21 of the sleeve 20 to the flange 24, is arranged between the connecting portions 11a and 12a of the nonflammable resin plates 11 and 12. Through the connecting portions 11a and 12a, the nonflammable resin plates 11 and 12 are heat-welded to the sleeve 20. Moreover, under the consideration of a weak adhesion of the heat-welding on the nonflammable resin plates 11 and 12 and the sleeve 20, an adhesive can be used to improve the adhesion.

Besides the serious assemblies of the ink storage device 10, the ink receiving portion 13 formed by the nonflammable resin plates 11 and 12 needs to maintain in an airtight state, and thus as illustrated in FIG. 2, a wider area is needed for the connecting portion 11a and 12a while proceeding of heat-welding on the nonflammable resin plates 11 and 12. Also, the gap width of the cut 35 has to be modified under the consideration of keeping airtight without any external force applied thereon. Furthermore, the connecting portions 11a and 12a of the nonflammable resin plates 11 and 12 are attached along the peripheral of the first end portion 21 of the sleeve 20 so as no damage to the airtight state.

The ink receiving portion 13 of the ink storage device 10 assembled under the above procedure will need a gas removing process before the ink 2 is filled into the ink receiving portion 13 as illustrated in FIG. 2. During the process of removing the air, a needle of an attracting device which is not shown in the figure is inserted into the cut 35 to proceed with the gas removing process. While filling the ink 2 into the ink storage device 10 which the gas therein is removed, a needle of a ink filling device which is not shown in the figure is inserted into the cut 35 of the pin plug 30 to fill the ink 2 into the ink receiving portion 13 (referring to the FIG. 3).

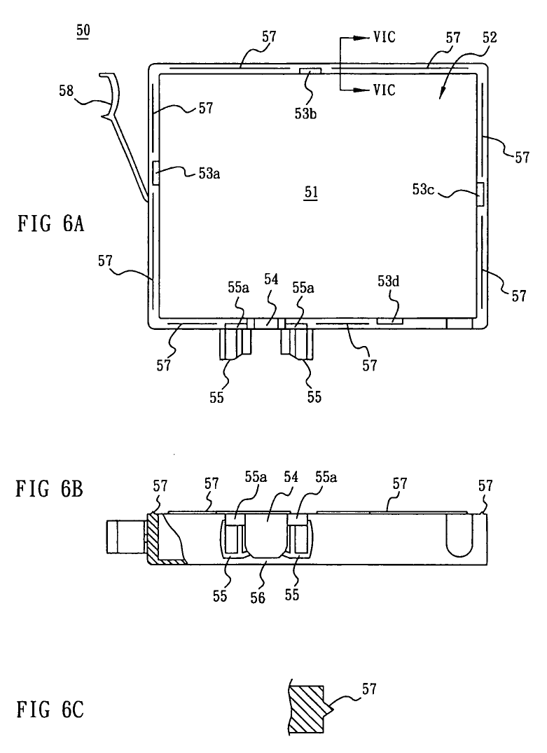

The casing 50 of the ink cartridge 1 is a box with an opening 52 at one side thereof as shown in the FIGS. 6A, 6B and 6C. Inside the casing 50, there is an arranging portion 51 for receiving the ink storage device 10. All the inner four sidewalls of the casing 50 are formed with slots 53a to 53d for combining and positioning the cover 60. Moreover, on one side wall of the casing 50, an exposing portion 54 formed by a breach serves to expose out the second end portion 22 of the sleeve 20. Besides, on the outer wall of the left side wall of the casing 50 shown in the FIG. 6A, a fastening sheet 58 is formed for fastening the ink cartridge 1 to the printer device (not illustrated).

A guiding protrusion 55 guiding the installation of the ink storage device 10 is formed on both sides of the exposing portion 54 of the sleeve 20 on the casing 50. Through the position illustrated in the figure, the guiding protrusion 55 is formed outwards and perpendicular to the bottom side wall of casing 50. Meanwhile, the positioning rib 56 is formed on the breach of the exposing portion 54 for fixing the mentioned notch 25 of the sleeve 20 so as to position the ink storage device 10 in the casing 50.

Furthermore, on top ends of all the four side walls of the opening 52 of the casing 50, welding ribs 57 is protruding from the top ends of all the four side walls as shown in FIG. 6C. The welding rib 57 will be inserted into welding grooves 65 of the cover 60 which will be mentioned in the following for increasing the attaching area while installing the cover 60 to the casing 50.

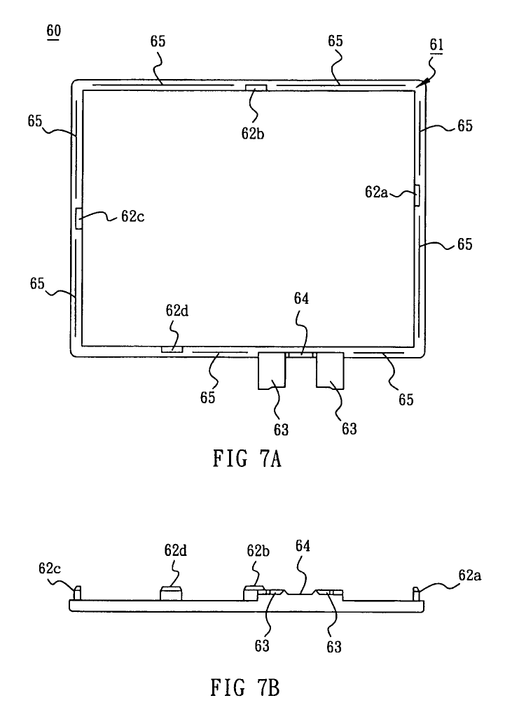

The cover 60 is formed by a plate material, for example, that identical to the one of the casing 50 and is used to cover upon the opening 52 of the casing 50 as shown in FIGS. 7A and 7B. FIG. 7A is a schematic drawing showing a side of the cover 60 that covers upon the open 52 of the casing 50. In the figure, an edge of each side is formed as an attaching area 61 which is attached to the top end of the opening 52 of the casing 50. There are claws 62a to 62d perpendicularly formed in an inner area of four sides of the attaching area 61, respectively. These claws match up with the positioning slots 53a to 53d of the casing 50 and can be used to position the cover 60 to the casing 50 properly.

As shown in FIG. 7A, on a lower side of the attaching area 61 of the cover 60, a perpendicular but lower (than the claws) positioning rib 64 is formed on an outer area. On each of two sides of the positioning rib 64, an approximately L shape guiding protrusion 63 in a side view is formed. In the state of connection between the casing 50 and the cover 60, the positioning rib 64 and the guiding protrusion 63 locate on a side of the exposing portion 54 of the opening 52 of the casing 50. The mentioned positioning rib 64 of the cover 60 and the positioning rib 56 of the casing 50 are embedded into the mentioned opposite notches 25 of the sleeve 20. Furthermore, the guiding protrusion 63 of the cover 60 is inserted into a section 55a formed by the edge of the opening of the exposing portion 54 in the casing 50. The extension end of the guiding protrusion 63 is arranged to the opposite guiding protrusion 55 of the casing 50 and covers the second end portion 22 of the sleeve 20. Moreover, on the surface of the attaching area 61, the welding grooves 65 are formed along the attaching area 61 of the cover 60.

In the following, the assembly method of the ink cartridge 1 including above components will be described.

Firstly, the ink storage device 10 is installed to the arranging portion 51 of the casing 50. Detailed, the sidewall of the second end portion 22 near the flange 24 of the sleeve 20 is attached to the inner wall of the exposing portion 54 of the casing 50 and than the sleeve 20 can be plugged into the exposing portion 54. The ink storage device 10 can be received in the casing 50 by sliding a part of the two notches 25 of the sleeve 20 to the positioning rib 56 of the casing 50. Secondly, the cover 60 covers upon the opening 52 of the casing 50 by inserting the claws 62a to 62d of the cover 60 into the positioning slots 53a to 53d of the casing 50. The casing 50 and the cover 60 can be attached and fixed by using an adhesive on the end of the opening 52 of casing 50 and the attaching area 61 of the cover 60. Meanwhile, the positioning rib 64 of the cover 60 will slide into the other part of the two mentioned notches 25 of the sleeve 20. By the connection, the second end portion 22 of the sleeve 20 is covered by the guiding protrusion 55 and 63 of the cover 60 and casing 50, respectively so that an “ink supplier” is formed.

By installing the ink cartridge 1 assembled under above description to an ink-jet printer (not illustrated in the figure), the “ink supplier” formed by the guiding protrusion 55 and 63 of the casing 50 and cover 60 of the mentioned ink cartridge 1 will closely attach to a link portion of nozzle of the printer (the same connection method with prior art and not shown in the figure). By pressing the “ink supplier”, the pin plug 30 in the ink storage device 10 will elastically deform and the cut 35 will be opened, then the ink 2 stored in the storage portion 34 will flow into the nozzle of the printer.

In the above description, the ink receiving portion 13 is formed by the nonflammable resin plates 11 and 12. By the process of supplying ink 2 to the nozzle of the printer device, the nonflammable resin plates 11 and 12 will gradually attaching to each other such like a leaking balloon and generate a shrinking pressure inside the ink receiving portion 13. Therefore, the ink storage device 10 can supply the ink 2 steadily until the ink receiving portion 13 is almost empty, while no air link and no airway as those used in the prior art are installed in the present invention.

While removing the ink cartridge 1 for supplying the ink 2 into the nozzle of the printer device, the elastic deformation of the pin plug 30 will be released away, thus closing the cut 35. Therefore, there is no ink dropping issue while removing the ink cartridge 1 from the nozzle of the printer.

The ink cartridge 1 according to the present invention has no porous medium which serves to preserve the ink as that adapted in the prior art, and the ink storage device 10 is designed as a seal state without an air inlet, so that less component for an ink cartridge 1 is needed. Also, there is no bubble generated in the ink because of no air inlet and it is unnecessary to remove the seal for a user.

Besides, the ink storage device 10 is used under a seal state, the effect of surroundings temperature, pressure, and vibration can be restrained. Moreover, the ink 2 inside the ink receiving portion 13 can be used entirely without residue because of the porous medium is not adopted.

The above embodiment of the ink cartridge 1 assembled by the casing 50 and the cover 60 is not used to confine the scope and spirit of the present invention. Embodiment of variations in the casing 50′ and cover 60′ will be described in the following. Among the following casing 50′ and cover 60′, common components with the former ones will use the same component number and ignore the description while different components will be described.

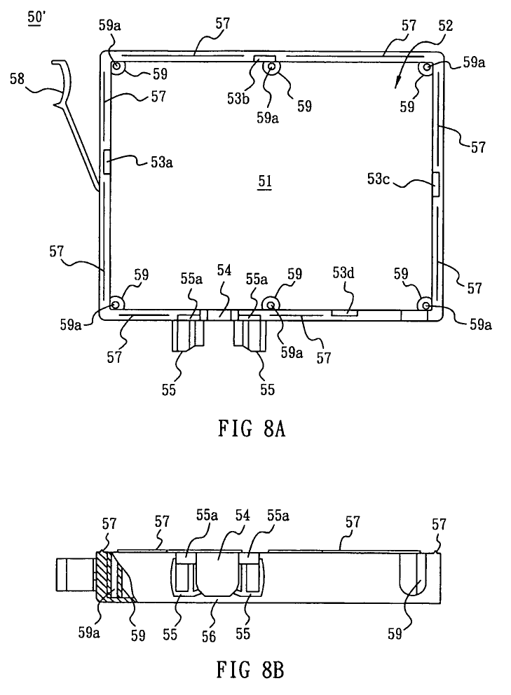

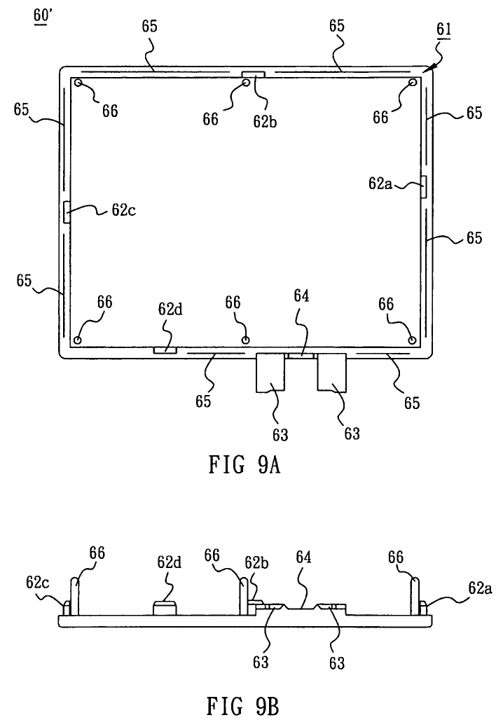

FIGS. 8A, 8B, 9A and 9B show the embodiment which is modified from the above ink cartridge 1 in the frame. In this embodiment, the frame is still assembled by the casing 50′ and cover 60′. Beside the structures of casing 50 of the above embodiment, a plurality of column sustaining portions 59 (there are six in FIG. 8) are formed aside the inner wall of the opening 52. The column sustaining portion 59 is formed in the corner of the receiving portion 51 and is perpendicularly to the opening 52, and a receiving hole 59a is formed in the top center thereof along an extension direction of the column sustaining portions 59.

FIG. 9 shows the cover 60′ with inserting pins 66 beside the inner edge of the attaching area 61. The numbers of the inserting pins match with the column sustaining portions 59 of the casing 50′ disclosed in FIG. 8. The inserting pins 66 is perpendicularly formed on the side of the cover 60′ covering upon the casing 50′, while the length thereof is shorter than the depth of the receiving hole 59a of the column sustaining portion 59.

The assembly of ink cartridge 1 by the casing 50′ and the cover 60′ illustrated in FIGS. 8A, 8B, 9A and 9B can be positioned by the slots 53a to 53d and the claws 62a to 62d of the casing 50 and the cover 60, and also can be positioned by the inserting pins 66 and the column sustaining portions 59. However, the connection between the casing 50′ and cover 60′ will become more stable by inserting the inserting pins 66 to the receiving holes 59a of the column sustaining portions 59.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An ink storage device comprising an ink receiving portion, a sleeve, and a pin plug, wherein
the ink receiving portion is formed by a pair of plates which are combined by welding and sealing;
the sleeve has a first end portion and a second end portion; the first end portion being communicated to the ink receiving portion and the second end portion exposes out of the ink receiving portion, and a penetrating hole is formed in the sleeve and is communicated to the ink receiving portion;
the pin plug is made of an elastic material and is installed to the second end portion of the sleeve; a storage portion for storing the ink is formed in the pin plug, and an end of the pin plug is formed as a linking hole linking the ink receiving portion with the storage portion through the penetrating hole; another end of the pin plug is formed as a cut which is acted as valve.

2. An ink storage device as claimed in claim 1, wherein the edges of the pair of plates clamp the first end of the sleeve and peripheries of the plates are welded so as to be fixed with the sleeve.

3. An ink storage device as claimed in claim 1, wherein the penetrating hole has a diameter-enlarged space at an opening in the second end of the sleeve and the pin plug is plugged and fixed into the space.

4. An ink storage device as claimed in claim 2, wherein the penetrating hole has a diameter-enlarged space at an opening in the second end of the sleeve and the pin plug is plugged and fixed into the space.

5. An ink cartridge including:
an ink storage device further comprising an ink receiving portion, a sleeve, and a pin plug, wherein
the ink receiving portion is formed by a pair of plates which are combined by welding and sealing;
the sleeve has a first end portion and a second end portion; the first end portion being communicated to the ink receiving portion and the second end portion exposes out of the ink receiving portion, and a penetrating hole is formed in the sleeve and is communicated to the ink receiving portion;
the pin plug is made of an elastic material and is installed to the second end portion of the sleeve; a storage portion for storing the ink is formed in the pin plug, and an end of the pin plug is formed as a linking hole linking the ink receiving portion with the storage portion through the penetrating hole; another end of the pin plug is formed as a cut which is acted as valve; and
a frame for receiving the ink storage device.

6. An ink cartridge as claimed in claim 5, wherein the edges of the pair of plates clamp the first end of the sleeve and peripheries of the plates are welded so as to be fixed with the sleeve.

7. An ink cartridge as claimed in claim 5, wherein the penetrating hole has a diameter-enlarged space at an opening in the second end of the sleeve and the pin plug is plugged and fixed into the space.

8. An ink cartridge as claimed in claim 6, wherein the penetrating hole has a diameter-enlarged space at an opening in the second end of the sleeve and the pin plug is plugged and fixed into the space.

9. An ink cartridge as claimed in claim 5, wherein the frame is formed by a casing and a cover; the casing is a box having an opening, and the cover covers upon an opening of the casing; the casing has an arranging portion for receiving the ink storage device and an exposing portion for fixing the sleeve and exposing out a second end portion of the sleeve.

10. An ink cartridge as claimed in claim 6, wherein the frame is formed by a casing and a cover; the casing is a box having an opening, and the cover covers upon an opening of the casing; the casing has an arranging portion for receiving the ink storage device and an exposing portion for fixing the sleeve and exposing out a second end portion of the sleeve.

11. An ink cartridge as claimed in claim 7, wherein the frame is formed by a casing and a cover; the casing is a box having an opening, and the cover covers upon an opening of the casing; the casing has an arranging portion for receiving the ink storage device and an exposing portion for fixing the sleeve and exposing out a second end portion of the sleeve.

12. An ink cartridge as claimed in claim 8, wherein the frame is formed by a casing and a cover; the casing is a box having an opening, and the cover covers upon an opening of the casing; the casing has an arranging portion for receiving the ink storage device and an exposing portion for fixing the sleeve and exposing out a second end portion of the sleeve.

13. An ink cartridge as claimed in claim 9, wherein the sleeve has at least one notch, and at least one of the casing and the cover is formed with a positioning rib which is retained to the notch so as to determine a position of the ink storage device.

14. An ink cartridge as claimed in claim 10, wherein the sleeve has at least one notch, and at least one of the casing and the cover is formed with a positioning rib which is retained to the notch so as to determine a position of the ink storage device.

15. An ink cartridge as claimed in claim 11, wherein the sleeve has at least one notch, and at least one of the casing and the cover is formed with a positioning rib which is retained to the notch so as to determine a position of the ink storage device.

16. An ink cartridge as claimed in claim 12, wherein the sleeve has at least one notch, and at least one of the casing and the cover is formed with a positioning rib which is retained to the notch so as to determine a position of the ink storage device.

17. An ink cartridge as claimed in claim 9, wherein the opening of the casing has welding ribs and the cover has welding grooves at positions corresponding to those of the welding ribs.

18. An ink cartridge as claimed in claim 13, wherein the opening of the casing has welding ribs and the cover has welding grooves at positions corresponding to those of the welding ribs.

19. An ink cartridge as claimed in claim 9, wherein an inner wall of the cover facing the opening of the casing is formed with at least one inserting pin; a column sustaining portion is formed on a corresponding position in the casing; and a receiving hole receiving the inserting pin is formed on a top of the column sustaining portion.

20. An ink cartridge as claimed in claim 13, wherein an inner wall of the cover facing the opening of the casing is formed with at least one inserting pin; a column sustaining portion is formed on a corresponding position in the casing; and a receiving hole receiving the inserting pin is formed on a top of the column sustaining portion.
